(19) United States
(12) Patent Application Publication
(10) Pub. No.: US 2024/0170776 A1
(43) Pub. Date: May 23, 2024

(54) METHOD FOR PRODUCING POWER STORAGE DEVICE AND POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Tsuyoshi EHARA, Toyota-shi (JP); Yozo UCHIDA, Toyota-shi (JP); Yuki SATO, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Takashi TAKIMOTO, Kosai-shi (JP); Shigeru MATSUMOTO, Toyohashi-shi (JP); Yasuaki NAGANO, Kosai-shi (JP)

(21) Appl. No.: 18/475,211

(22) Filed: Sep. 27, 2023

(30) Foreign Application Priority Data
Nov. 21, 2022 (JP) 2022-185484

(51) Int. Cl. H01M 50/188; H01M 50/103; H01M 50/176; H01M 50/193

(52) U.S. Cl. CPC H01M 50/188; H01M 50/103; H01M 50/176; H01M 50/193; H01G 11/82

(57) ABSTRACT

A method for producing a power storage device includes an insert-molding step in which a resin member is formed by insert molding with a terminal member inserted in an insertion hole of a case member. This insert-molding step is performed using a molding mold that includes a top-surface contact portion which is to face and tightly contact with a terminal top surface of the terminal member, an inner annular flat portion and an outer annular flat portion to form a frame top surface of the resin member, and an annular protruding portion to form an annular groove of the resin member.

### CROSS-REFERENCE TO RELATED APPLICATIONS

This application is based upon and claims the benefit of priority to Japanese Patent Application No. 2022-185484 filed on Nov. 21, 2022, the entire contents of which are incorporated herein by reference.

### BACKGROUND

### Technical Field

The present disclosure relates to a method for producing a power storage device and the power storage device, such as a battery or a capacitor, in which a terminal member is fixed via a resin member to a case member that constitutes a part of a case.

### Related Art

As a power storage device, there is known a rectangular battery in which positive and negative terminal members are each fixed to a case having a rectangular parallelepiped box-like shape via an insert-molded resin member. Specifically, the case is composed of: a bottomed rectangular tube-shaped case body having a rectangular ring-shaped opening portion; and a rectangular plate-shaped lid which is joined to the case body over the entire circumference thereof to close the opening portion. In addition, the positive and negative terminal members are inserted individually in a pair of insertion holes provided in the lid, and extend from the inside to the outside of the case. A pair of resin members are joined to the lid and the terminal members, while insulating between the lid and the terminal members, to fix the terminal members to the lid.

Such a battery is assembled by the following method. That is, the positive and negative terminal members are inserted individually into the insertion holes of the lid. In this state, the resin members are made by insert-molding to integrate the terminal members with the lid via the resin members, forming a lid assembly. Subsequently, the positive and negative terminal members of this lid assembly are connected to positive and negative current collecting portions of an electrode body, respectively. Then, the electrode body is inserted into the case body, and the opening portion of the case body is closed with the lid, and laser welding is performed on the entire circumference thereof to form the case. Examples of a related conventional art are disclosed in Japanese unexamined patent application publications Nos. 2010-272324 (JP2010-272324 A) and 2018-097978 (JP2018-097978 A) (see FIGS. 1 and 2 of JP2010-272324 A and FIGS. 1 to 3 of JP2018-097978 A).

### SUMMARY

### Technical Problems

Furthermore, as the above-described battery, there is a battery including positive and negative terminal members including flat terminal top surfaces. Specifically, in this battery, each terminal member includes a terminal outer portion which is located outside a lid (i.e., a case member) and which includes a flat terminal top surface, and each resin member includes a resin outer frame portion which is located outside the lid (i.e., the case member), which has a frame shape surrounding the terminal outer portion of the terminal member, and which is flush with the terminal top surface of the terminal outer portion. As for the battery configured as above, during the above-described insert-molding, a part of molten resin supplied around each terminal outer portion in order to form each resin outer frame portion flows between the terminal top surface of the terminal outer portion and a molding mold. This may result in the formation of resin burrs on the terminal top surface after insert-molding.

The present disclosure has been made in view of such circumstances, and provides a method for producing a power storage device, and the power storage device produced by this method, which can prevent generation of resin burrs on a terminal top surface of a terminal member.

### Means of Solving the Problems

(1) To achieve the above purpose, one aspect of the present disclosure provides a method for producing a power storage device, the power storage device including: a case member including an insertion hole; a terminal member inserted in the insertion hole of the case member; and an insert-molded resin member joined to the case member and the terminal member while insulating between the case member and the terminal member, to fix the terminal member to the case member, the terminal member including a terminal outer portion located on an outer side of the case member, the terminal outer portion including a terminal top surface having an entirely exposed flat shape, the resin member including: a resin outer frame portion located on the outer side of the case member, having a frame shape that surrounds the terminal outer portion of the terminal member, and including a frame top surface flush with the terminal top surface of the terminal outer portion; and an annular groove along an entire circumference of the resin outer frame portion on the frame top surface of the resin outer frame portion, the method comprising: insert-molding the resin member in a state where the terminal member is inserted in the insertion hole of the case member, wherein insert-molding the resin member is performed using a molding mold that includes: a flat top-surface contact portion which is to face and tightly contact with the terminal top surface of the terminal member; an inner annular flat portion and an outer annular flat portion, which are formed in a double ring shape surrounding the top-surface contact portion, to form the frame top surface of the resin member; and an annular protruding portion provided between the inner annular flat portion and the outer annular flat portion, to form the annular groove of the resin member.

In the above-described method for producing the power storage device, in the insert-molding process, the resin member including the annular groove on the frame top surface of the resin outer frame portion is formed by insert-molding using the above-described molding mold including the annular protruding portion, and others. This reduces the amount of molten resin needed to be supplied into the mold, around the terminal outer portion of the terminal member, in order to form the resin outer frame portion. Thus, the molten resin is less likely to flow, or enter, between the top-surface contact portion of the molding mold and the terminal top surface of the terminal outer portion of the terminal member. In addition, since the molding mold is provided with the annular protruding portion, the molten resin is not allowed to swiftly move radially inward relative to the annular protruding portion. This makes it difficult for the molten resin to flow between the top-surface contact portion of the molding mold and the terminal top surface of the terminal outer portion. Accordingly, this method can prevent generation of resin burrs on the terminal top surface.

(2) Another aspect of the present disclosure provides a power storage device comprising: a case member including an insertion hole; a terminal member inserted in the insertion hole of the case member; and an insert-molded resin member joined to the case member and the terminal member while insulating between the case member and the terminal member, to fix the terminal member to the case member, wherein the terminal member includes a terminal outer portion located on an outer side of the case member, the terminal outer portion including a terminal top surface having an entirely exposed flat shape, and the resin member includes: a resin outer frame portion located on the outer side of the case member, having a frame shape that surrounds the terminal outer portion of the terminal member, and including a frame top surface flush with the terminal top surface of the terminal outer portion; and an annular groove along an entire circumference of the resin outer frame portion on the frame top surface of the resin outer frame portion.

In the above-described power storage device, since the insert-molded resin member includes the annular groove over the entire circumference on the frame top surface of the resin outer frame portion thereof, the terminal top surface has no resin burr thereon and is entirely exposed. Therefore, the entire terminal top surface can be appropriately used for connection to an external terminal, such as a busbar.

### BRIEF DESCRIPTION OF THE DRAWINGS

FIG. 1 is a perspective view of a battery in an embodiment;

FIG. 2 is a cross-sectional view of the battery in the embodiment, taken along a battery height direction and a battery width direction;

FIG. 3 is a partially enlarged top view of a terminal member and a resin member of the battery, and their surroundings in the embodiment;

FIG. 4 is a cross-sectional view of the terminal member and the resin member of the battery, and their surroundings in the embodiment, as seen in a direction indicated by arrows A-A in FIGS. 3 and 5;

FIG. 5 is a cross-sectional view of the terminal member and the resin member of the battery, and their surroundings in the embodiment, as seen in a direction indicated by arrows B-B in FIGS. 3 and 4;

FIG. 6 is a flowchart showing a method for producing the battery in the embodiment;

FIG. 7 illustrates a state where molten resin is injected through a gate into a cavity in an insert-molding step in the method for producing the battery in the embodiment; and

FIG. 8 illustrates a state where a resin member is molded in the cavity in the insert-molding step in the method for producing the battery in the embodiment.

### DETAILED DESCRIPTION OF THE EXEMPLARY EMBODIMENTS

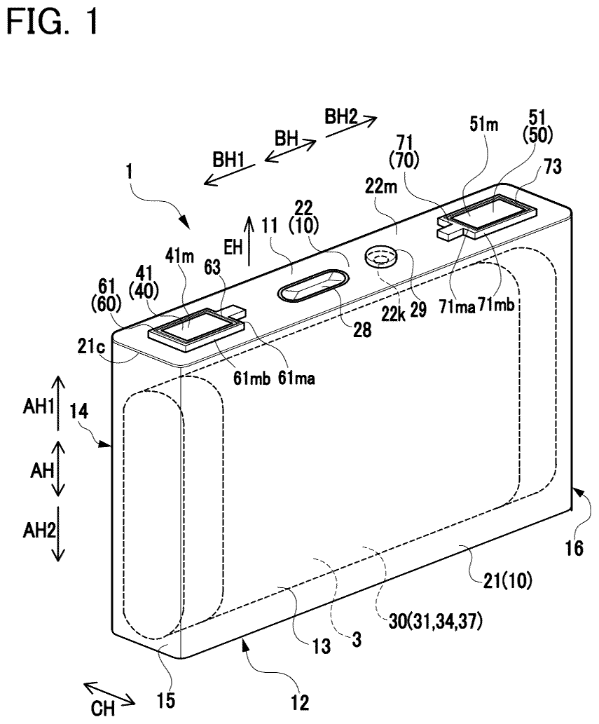

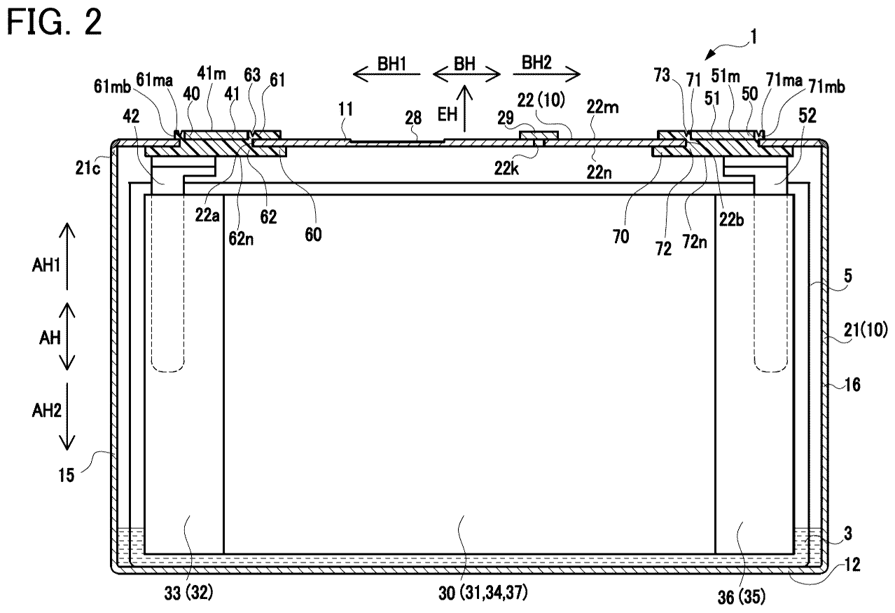

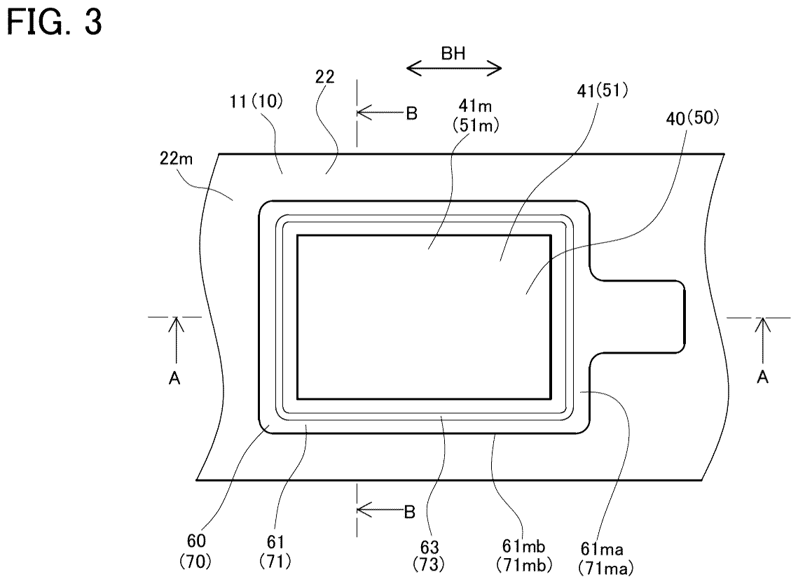

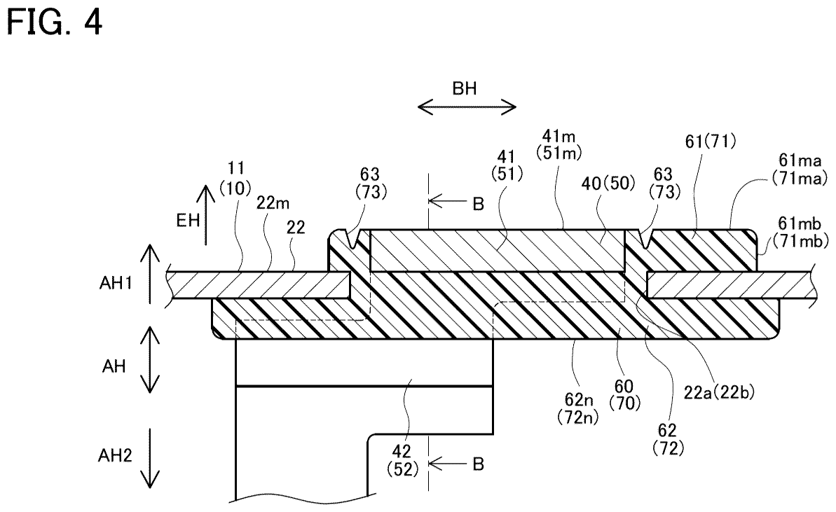

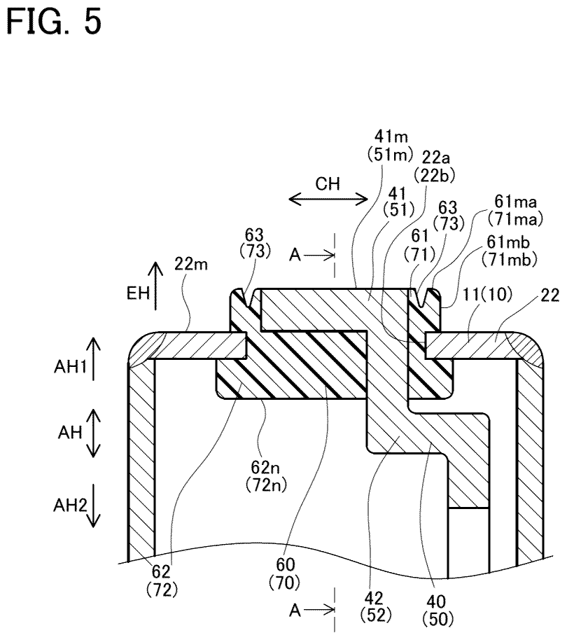

Hereinafter, an embodiment of the present disclosure will be described with reference to the accompanying drawings. FIG. 1 shows a perspective view of a battery (one example of a power storage device of the present disclosure) 1 of the present embodiment, and FIG. 2 shows a cross-sectional view of the battery 1. FIG. 3 shows a partially enlarged top view of a terminal member 40 and a resin member 60, and their surroundings. FIGS. 4 and 5 are partially enlarged cross-sectional views of the terminal member 40 and the resin member 60, and their surroundings. It is to be noted that a terminal member 50 and a resin member 70 are respectively identical in configuration to the terminal member 40 and the resin member 60 and therefore the reference signs of the terminal member 50, the resin member 70, and their parts are noted together in parentheses. In the following, a description will be given with a battery height direction AH, a battery width direction BH, and a battery thickness direction CH of the battery 1 being defined as directions shown in FIGS. 1 to 5. The battery 1 is a rectangular, i.e., a rectangular parallelepiped-shaped, sealed lithium-ion secondary battery which will be installed in a vehicle, such as a hybrid car, a plug-in hybrid car, and an electric car.

The battery 1 includes a case 10, a flat wound electrode body 30 housed in the case 10, a positive terminal member 40 and the negative terminal member 50 supported on a case upper portion 11, i.e., a lid 22, of the case 10, and others. In the case 10, the electrode body 30 is covered with a bag-shaped insulating holder 5 formed of an insulating film, opening on an upper side AH1 in the battery height direction AH. In addition, the case 10 contains therein an electrolyte 3, a part of which is impregnated in the electrode body 30 and the remaining part of which is accumulated on a case bottom portion 12 of the case 10.

The case 10 is made of a metal (e.g., aluminum in the present embodiment) and has a rectangular parallelepiped box-like shape. This case 10 includes the rectangular case upper portion 11 located on the upper side AH1 in the battery height direction AH, the rectangular case bottom portion 12 opposing the case upper portion 11 and located on a lower side AH2 in the battery height direction AH, and four rectangular case side portions 13, 14, 15, and 16 connecting these portions 11 and 12. Specifically, the case 10 includes: a bottomed rectangular tube-shaped case body 21 including a rectangular ring-shaped opening portion 21c on the upper side AH1; and the rectangular plate-shaped lid (one example of a case member of the present disclosure) 22 laser-welded to the case body 21 over the entire circumference thereof to close the opening portion 21c.

The case upper portion 11 (i.e., the lid 22) is provided with a safety valve 28 which will break open when the internal pressure of the case 10 exceeds a valve opening pressure. The lid 22 is also provided with a liquid inlet 22k which communicates between the inside and the outside of the case 10, and the liquid inlet 22k is hermetically sealed with a disc-shaped sealing member 29 made of aluminum.

Furthermore, the lid 22 is provided with two rectangular insertion holes 22a and 22b, which are located near an end on one side BH1 and near an end on the other side BH2 in the battery width direction BH, respectively. The positive terminal member 40 made of aluminum is inserted in the insertion hole 22a, and is fixed to the lid 22 via the resin member 60 insulating the positive terminal member 40 from the case 10. In addition, the negative terminal member 50 made of copper is inserted in the other insertion hole 22b, and is fixed to the lid 22 via a resin member 70 insulating the negative terminal member 50 from the case 10.

These terminal members 40 and 50 are each produced by punching a metal plate (concretely, an aluminum plate for the positive terminal member 40 and a copper plate for the negative terminal member 50) into a predetermined shape and bending the metal plate. The terminal members 40 and 50 respectively include terminal outer portions 41 and 51 located outside the lid 22 on an outer side EH, and terminal inner portions 42 and 52 mainly located inside the case 10 and respectively connected to the terminal outer portions 41 and 51 via the insertion holes 22a and 22b. The terminal outer portions 41 and 51 each have a rectangular flat plate-like shape, and include rectangular flat terminal top surfaces 41m and 51m, respectively. These terminal top surfaces 41m and 51m thus have no resin burrs and are each exposed entirely. The positive terminal inner portion 42 is joined and electrically conductive to a positive current collecting portion 33 of the electrode body 30, which will be described later, in the case 10. Meanwhile, the negative terminal inner portion 52 is joined and electrically conductive to a negative current collecting portion 36 of the electrode body 30, which will be described later, in the case 10.

Next, the resin members 60 and 70 will be described. The resin member 60 is joined to the lid 22 and the positive terminal member 40 while insulating between the lid 22 and the terminal member 40, to fix the terminal member 40 to the lid 22. In addition, the resin member 70 is joined to the lid 22 and the negative terminal member 50 while insulating between the lid 22 and the terminal member 50, to fix the terminal member 50 to the lid 22.

These resin members 60 and 70 are made of polyphenylene sulfide (PPS), and include resin outer frame portions 61 and 71 which are located outside the lid 22 on the outer side EH, and resin inner portions 62 and 72 which are located inside the case 10 and in the insertion holes 22a and 22b of the lid 22 and which are connected to the resin outer frame portions 61 and 71, respectively. The resin outer frame portion 61 insulates between the terminal outer portion 41 of the terminal member 40 and the lid 22, and the resin outer frame portion 71 insulates between the terminal outer portion 51 of the terminal member 50 and the lid 22. Meanwhile, the resin inner portion 62 insulates between the terminal inner portion 42 of the terminal member 40 and the lid 22, while the resin inner portion 72 insulates between the terminal inner portion 52 of the terminal member 50 and the lid 22.

The resin outer frame portion 61 has a frame shape surrounding the terminal outer portion 41 of the terminal member 40, and includes a frame top surface 61ma flush with the terminal top surface 41m of the terminal outer portion 41, and a frame side surface 61mb extending from the periphery of the frame top surface 61ma to the lower side AH2. Similarly, the resin outer frame portion 71 has a frame shape surrounding the terminal outer portion 51 of the terminal member 50, and includes a frame top surface 71ma flush with the terminal top surface 51m of the terminal outer portion 51, and a frame side surface 71mb extending from the periphery of the frame top surface 71ma to the lower side AH2. The frame top surfaces 61ma and 71ma are respectively formed thereon with annular grooves 63 and 73, which have a rectangular ring shape extending over the entire circumferences of the resin outer frame portions 61 and 71 and having a V-shaped cross-section.

Next, the electrode body 30 will be described. The electrode body 30 is produced in such a manner that a strip-shaped positive electrode plate 31 and a strip-shaped negative electrode plate 34 are stacked alternately so that a pair of separators 37, each composed of a strip-shaped porous resin film, are interposed one between the electrode plates 31 and 34, and this stacked assembly is wound into a cylindrical shape, and then pressed into a flat shape. The electrode body 30 is housed in the case 10 oriented sideways with its axis coinciding with the battery width direction BH. An end portion of the electrode body 30 on the one side BH1 in the battery width direction BH is the positive current collecting portion 33 in which a positive current collecting foil 32 of the positive electrode plate 31 protrudes in a spiral form. The positive current collecting portion 33 is joined to the terminal inner portion 42 of the positive terminal member 40. Another end portion of the electrode body 30 on the other side BH2 in the battery width direction BH is the negative current collecting portion 36 in which a negative current collecting foil 35 of the negative electrode plate 34 protrudes in a spiral form. The negative current collecting portion 36 is joined to the terminal inner portion 52 of the negative terminal member 50.

In the battery 1 of the present embodiment, the resin members 60 and 70 which are formed by insert-molding described later respectively include the annular grooves 63 and 73 along the entire circumferences on the frame top surfaces 61ma and 71ma of the resin outer frame portions 61 and 71. Thus, there are no resin burrs on the terminal top surfaces 41m and 51m of the terminal members 40 and 50, and the entire terminal top surfaces 41m and 51m are exposed, i.e., uncovered. Therefore, the entire terminal top surfaces 41m and 51m can be appropriately used for connection to external terminals such as busbars.

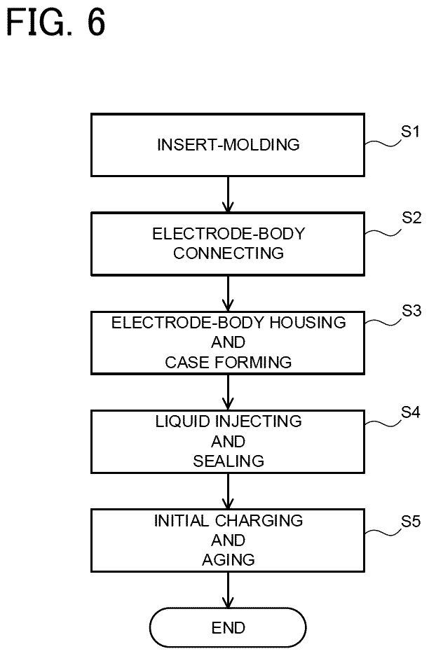

Next, a method for producing the battery 1 will be described (see FIGS. 6 to 8). The lid 22 and the terminal members 40 and 50 are prepared in advance. Specifically, the lid 22 is obtained by punching an aluminum plate into a predetermined shape with the liquid inlet 22k, the insertion holes 22a and 22b, and the safety valve 28. In addition, the positive terminal member 40 is obtained by punching an aluminum plate into a predetermined shape and bending the aluminum plate, and similarly the negative terminal member 50 is obtained by punching a copper plate into a predetermined shape and bending the copper plate.

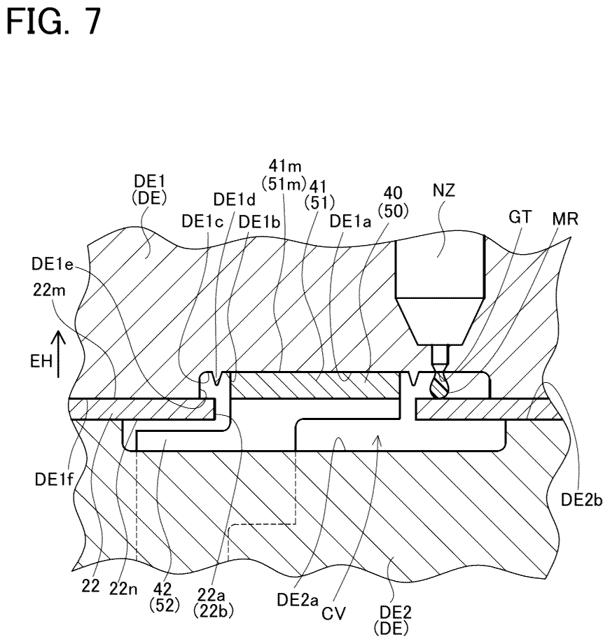

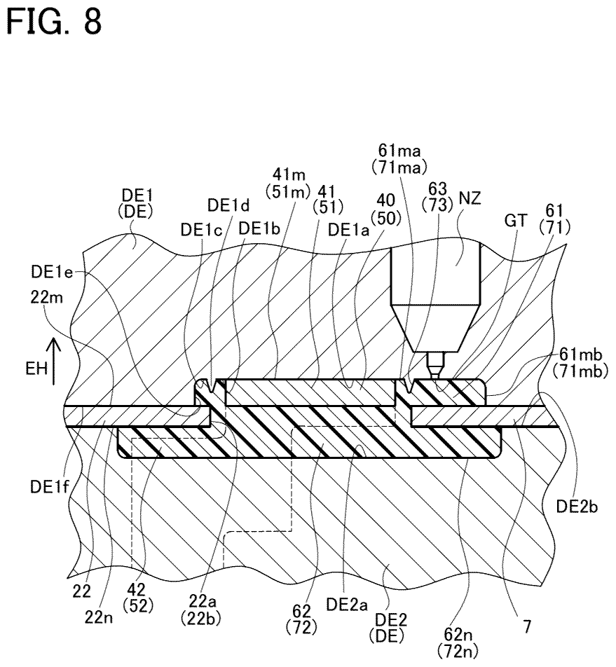

Then, in an insert-molding step S1 (see FIG. 6), with the terminal members 40 and 50 inserted in the insertion holes 22a and 22b of the lid 22, respectively, the resin members 60 and 70 are made by insert-molding to form a lid assembly 7 including the lid 22 integrated with the terminal members 40 and 50 (see FIGS. 7 and 8). This insert-molding step S1 is performed using a molding mold DE including an upper mold DE1 and a lower mold DE2 (see FIG. 7).

In the upper mold DE1, a pair of injection nozzles NZ are installed. These nozzles NZ are each configured to inject molten resin MR through a gate GT formed at the tip end into each of cavities CV provided in a pair, one of which is defined by the lid 22, the terminal member 40, and the molding mold DE and the other of which is defined by the lid 22, the terminal member 50, and the molding mold DE.

The upper mold DE1 includes a pair of flat top-surface contact portions DE1a which is to face and tightly contact with the terminal top surfaces 41m and 51m of the terminal outer portions 41 and 51 of the terminal members 40 and 50, respectively. The upper mold DE1 further includes double ring-shaped inner annular flat portions DE1b and outer annular flat portions DE1c surrounding the respective top-surface contact portions DE1a to form the frame top surfaces 61ma and 71ma of the resin outer frame portions 61 and 71 of the resin members 60 and 70, and annular protruding portions DE1d provided between the inner annular flat portions DE1b and the outer annular flat portions DE1c to form the annular grooves 63 and 73 on the frame top surfaces 61ma and 71ma. The upper mold DE1 further includes a pair of side-surface forming portions DE1e extending downward from the respective outer annular flat portions DE1c to form the frame side surfaces 61mb and 71mb of the resin outer frame portions 61 and 71 of the resin members 60 and 70, and a flat lid contact portion DE1f surrounding each side-surface forming portion DE1e and extending radially outward. This lid contact portion DE1f is to face and tightly contact with a lid outer surface 22m of the lid 22.

Meanwhile, the lower mold DE2 includes a pair of inner-surface forming portions DE2a for forming inner surfaces 62n and 72n of the resin inner portions 62 and 72 of the resin members 60 and 70, and a flat lid contact portion DE2b surrounding each inner-surface forming portion DE2a and extending radially outward, which is to face and contact with a lid inner surface 22n of the lid 22.

In the insert-molding step S1, first, the lid 22 is placed at a predetermined position in the lower mold DE2. Subsequently, the terminal members 40 and 50 are respectively inserted into the insertion holes 22a and 22b of the lid 22 placed in the lower mold DE2. Then, the upper mold DE1 is moved downward and placed on the lower mold DE2 to close the molding mold DE. At that time, the upper mold DE1 is placed such that the respective top-surface contact portions DE1a face and tightly contact with the terminal top surfaces 41m and 51m of the terminal members 40 and 50, and the lid contact portion DE1f faces and tightly contacts with the lid outer surface 22m of the lid 22. In addition, the lid contact portion DE2b of the lower mold DE2 faces and tightly contacts with the lid inner surface 22n of the lid 22.

Subsequently, the molten resin MR is injected through each gate GT into each cavity CV and spread over the entire cavity CV. At that time, since the upper mold DE1 is provided with the annular protruding portions DE1d, the amount of the molten resin MR supplied into the cavities CV around the terminal outer portions 41 and 51 of the terminal members 40 and 50 is smaller than that in the case where no annular protruding portions DE1d are provided. Therefore, the molten resin MR is less likely to flow, or enter, between the top-surface contact portions DE1a of the upper mold DE1 and the terminal top surfaces 41m and 51m of the terminal outer portions 41 and 51. In addition, since the upper mold DE1 is provided with the annular protruding portions DE1d, the molten resin MR is not allowed to swiftly move radially inward relative to the annular protruding portions DE1d. This makes it difficult for the molten resin MR to flow between the top-surface contact portions DE1a of the upper mold DE1 and the terminal top surfaces 41m and 51m of the terminal outer portions 41 and 51.

Then, the molten resin MR filled in each entire cavity CV is cooled, forming the resin members 60 and 70 in the cavities CV. After that, the upper mold DE1 is moved upward, and the lid assembly 7 in which the terminal members 40 and 50 are fixed to the lid 22 via the resin members 60 and 70 respectively is taken out from the lower mold DE2.

Next, in an electrode-body connecting step S2 (see FIG. 6), the electrode body 30 produced by winding the strip-shaped positive electrode plate 31, the strip-shaped negative electrode plate 34, and the strip-shaped separators 37, which are alternately stacked on on another, and pressing these wound electrode plates 31 and 34 and separators 37 into a flat shape, is prepared. Further, the terminal inner portions 42 and 52 of the terminal members 40 and 50 of the above-described lid assembly 7 are ultrasonically welded to the positive current collecting portion 33 and the negative current collecting portion 36 of the electrode body 30, respectively (see FIG. 1 and FIG. 2). Then, the electrode body 30 is enclosed in the bag-shaped insulating holder 5.

In an electrode-body housing and case forming step S3, the case body 21 is prepared, the electrode body 30 covered with the insulating holder 5 is inserted into the case body 21, and the opening portion 21c of the case body 21 is closed with the lid 22. Then, the opening portion 21c of the case body 21 and a peripheral edge portion of the lid 22 are laser-welded together over their entire circumference to complete the case 10 with the electrode body 30 housed therein.

In a liquid injecting and sealing step S4, the electrolyte 3 is injected into the case 10 through the liquid inlet 22k, so that the electrode body 30 is impregnated therewith. Then, the liquid inlet 22k is covered with the sealing member 29 from the outside, and the sealing member 29 is laser-welded to the lid 22 to hermetically seal between the sealing member 29 and the lid 22.

In an initial charging and aging step S5, a charging device (not shown) is connected to the battery 1, and initial charging is performed on the battery 1. Then, the initially charged battery 1 is allowed to stand for a predetermined time to age. Thus, the battery 1 is completed.

As described above, in the method for producing the battery 1, in the insert-molding step S1, the resin members 60 and 70 respectively including the annular grooves 63 and 73 on the frame top surfaces 61ma and 71ma of the resin outer frame portions 61 and 71 are made by insert-molding using the molding mold DE which includes the upper mold DE1 including the annular protruding portions DE1d, and others. This configuration reduces the amount of the molten resin MR needed to be supplied into the molding mold DE, around the terminal outer portions 41 and 51 of the terminal members 40 and 50, in order to form the resin outer frame portions 61 and 71. Thus, the molten resin MR is less likely to flow between the top-surface contact portions DE1a of the upper mold DE1 and each of the terminal top surfaces 41m and 51m of the terminal outer portions 41 and 51. In addition, since the upper mold DE1 is provided with the annular protruding portions DE1d, the molten resin MR is not allowed to swiftly move radially inward relative to the annular protruding portions DE1d. This makes it difficult for the molten resin MR to flow between the top-surface contact portions DE1a of the upper mold DE1 and each of the terminal top surfaces 41m and 51m of the terminal outer portions 41 and 51. Accordingly, the foregoing method can prevent generation of resin burrs on the terminal top surfaces 41m and 51m.

While the present disclosure has been described above based on the embodiment, it should be understood that the present disclosure is not limited to the embodiment but can be applied with modifications appropriately made thereto without departing from the scope of the gist of the present disclosure.

### REFERENCE SIGNS LIST

1 Battery (Power storage device)
10 Case
21 Case body
22 Lid (Case member)
22a, 22b Insertion hole
30 Electrode body
40, 50 Terminal member
41, 51 Terminal outer portion
41m, 51m Terminal top surface
60, 70 Resin member
61m, 71m Resin outer frame portion
61ma, 71ma Frame top surface
63, 73 Annular groove
EH Outer side (of Lid)
DE Molding mold
DE1 Upper mold
DE1a Top-surface contact portion
DE1b Inner annular flat portion
DE1c Outer annular flat portion
DE1d Annular protruding portion
DE2 Lower mold
MR Molten resin

What is claimed is:

1. A method for producing a power storage device,
the power storage device including:
a case member including an insertion hole;
a terminal member inserted in the insertion hole of the case member; and
an insert-molded resin member joined to the case member and the terminal member while insulating between the case member and the terminal member, to fix the terminal member to the case member,
the terminal member including a terminal outer portion located on an outer side of the case member, the terminal outer portion including a terminal top surface having an entirely exposed flat shape,
the resin member including:
a resin outer frame portion located on the outer side of the case member, having a frame shape that surrounds the terminal outer portion of the terminal member, and including a frame top surface flush with the terminal top surface of the terminal outer portion; and
an annular groove along an entire circumference of the resin outer frame portion on the frame top surface of the resin outer frame portion,
the method comprising:
insert-molding the resin member in a state where the terminal member is inserted in the insertion hole of the case member,
wherein insert-molding the resin member is performed using a molding mold that includes:
a flat top-surface contact portion which is to face and tightly contact with the terminal top surface of the terminal member;
an inner annular flat portion and an outer annular flat portion, which are formed in a double ring shape surrounding the top-surface contact portion, to form the frame top surface of the resin member; and
an annular protruding portion provided between the inner annular flat portion and the outer annular flat portion, to form the annular groove of the resin member.

2. A power storage device comprising:
a case member including an insertion hole;
a terminal member inserted in the insertion hole of the case member; and
an insert-molded resin member joined to the case member and the terminal member while insulating between the case member and the terminal member, to fix the terminal member to the case member,
wherein the terminal member includes a terminal outer portion located on an outer side of the case member, the terminal outer portion including a terminal top surface having an entirely exposed flat shape, and
the resin member includes:
a resin outer frame portion located on the outer side of the case member, having a frame shape that surrounds the terminal outer portion of the terminal member, and including a frame top surface flush with the terminal top surface of the terminal outer portion; and
an annular groove along an entire circumference of the resin outer frame portion on the frame top surface of the resin outer frame portion.
